(19) United States
(12) Patent Application Publication
(10) Pub. No.: US 2025/0251088 A1
(43) Pub. Date: Aug. 7, 2025

(54) INSTALLATION AND METHOD FOR STORING AND DISTRIBUTING CRYOGENIC FLUID

(71) Applicant: L'Air Liquide, Societe Anonyme pour l'Etude et l’Exploitation des Procedes Georges Claude, Paris (FR)

(72) Inventors: Wassim OUAKRIM, Sassenage (FR); Cyril BENISTAND-HECTOR, Sassenage (FR); Rasmey TRY, Sassenage (FR)

(21) Appl. No.: 19/041,566

(22) Filed: Jan. 30, 2025

(30) Foreign Application Priority Data
Feb. 1, 2024 (FR) FR 2400982

(51) Int. Cl. F17C 9/00

(52) U.S. Cl. CPC F17C 9/00; F17C 2221/012; F17C 2223/0161; F17C 2223/031; F17C 2225/0161; F17C 2227/0135; F17C 2250/0626; F17C 2265/037; F17C 2270/0142

(57) ABSTRACT

The invention relates to an installation for storing and distributing cryogenic fluid, for example liquid hydrogen, comprising a cryogenic reservoir which is buried below the ground, a liquid withdrawal circuit connected to the reservoir with a downstream end located above the ground and designed to be connected to a consumer, the withdrawal circuit comprising a cryogenic pump arranged above the ground, the installation comprising a pipe for the recovery of vaporization gas generated inside the cryogenic pump, having a downstream end connected to the reservoir, the pipe for the recovery of the vaporization gases comprising at least one device for controlling the pressure and/or flow rate of the vaporization gas returned to the reservoir and the device for controlling the pressure and/or flow rate being configured to control the pressure inside the reservoir at a pressure level which is greater than the pressure at the inlet of the cryogenic pump.

### CROSS REFERENCE TO RELATED APPLICATIONS

This application claims the benefit of priority under 35 U.S.C. § 119(a) and (b) to French patent application No. FR2400982, filed Feb. 1, 2024, which is herein incorporated by reference in its entirety.

### FIELD OF THE INVENTION

The invention relates to an installation and a method for storing and distributing cryogenic fluid.

### BACKGROUND OF THE INVENTION

The space requirement for the storage of hydrogen is a major issue. One solution is storage below ground. However, connecting a buried cryogenic storage facility with filling pumps above ground poses the problem of supplying these pumps during the different operating phases thereof. The supply of liquid to the pump is traditionally carried out by gravity, by having a sufficient level of liquid in the storage facility so that the liquid correctly reaches the inlet of the pump. Moreover, in cryogenic fuel stations, the pump requires cooling when started up and causes the evaporation of a part of its supply (vaporization gas “boil-off gas or BOG”). This vaporization gas is usually returned to the storage facility by lines which conduct the gas toward the top of the storage facility. When the storage facility is above the pump, this return takes place naturally. This function becomes more difficult to provide in a configuration where the high point of the storage facility is lower than the inlet of the pump.

One object of the present invention is to remedy all or some of the drawbacks of the prior art set forth above.

### SUMMARY OF THE INVENTION

In certain embodiments, the invention relates more particularly to an installation for storing and distributing cryogenic fluid, for example liquid hydrogen, comprising a cryogenic reservoir which is buried below the ground, a liquid withdrawal circuit comprising an upstream end connected to the reservoir and a downstream end located above the ground and designed to be connected to a consumer, the withdrawal circuit comprising a cryogenic pump arranged above the ground and the installation comprising a pipe for the recovery of vaporization gas generated inside the pump, having an upstream end connected to the pump and a downstream end connected to the reservoir.

In an effort to overcome the deficiencies of the prior art discussed, supra, the installation according to the invention, also according to the generic definition given by the above preamble, is configured such that the pipe for the recovery of the vaporization gases comprises at least one device for controlling the pressure and/or flow rate of the vaporization gas returned to the reservoir, the device for controlling the pressure and/or flow rate being configured to control the pressure inside the reservoir at a pressure level which is greater than the pressure at the inlet of the pump.

This arrangement makes it possible to guarantee a correct supply of the pump in order to ensure its operation by permitting the recovery of the vaporization gases from the pump in the storage facility, in order to reduce the overall losses of the station.

Moreover, embodiments of the invention can comprise one or more of the following features:
the device for controlling the pressure and/or flow rate is configured to control the pressure inside the reservoir at a level of between 5 mbar and 500 mbar above the pressure at the inlet of the pump,
the device for controlling the pressure and/or flow rate comprises at least one of: a heater, a heat exchanger and a compressor, for example a cryogenic compressor,
the device for controlling the pressure and/or flow rate comprises a heating heat exchanger and a compressor arranged in series,
the pipe for the recovery of the vaporization gases comprises two separate passages in the heating heat exchanger, respectively before and after compression in the compressor, in order to provide respectively a heating of the vaporization gas before compression and a cooling before injection into the reservoir,
the pipe for the recovery of the vaporization gases comprises a bypass line from the heat exchanger and an assembly of one or more valves configured to enable at least one part of the flow of vaporization gas to avoid passing into the heat exchanger,
the pipe for the recovery of the vaporization gases comprises a branching T-piece provided with a valve toward a discharge zone,
the installation comprises a device for pressurizing the reservoir which is autonomous and separate from the pipe for the recovery of the vaporization gases and the device for controlling,
the invention also relates to a method for the withdrawal of fluid using an installation according to any one of the features above or below, characterized in that it comprises the following steps: pumping of cryogenic liquid from the reservoir via the pump, recovery of the vaporization gas generated in the region of the pump, compression of the recovered vaporization gases and injection of the compressed gases into the reservoir at a determined pressure.

According to further possible particularities:
the compression of the recovered vaporization gases is carried out by a cryogenic compressor or by a non-cryogenic compressor, the vaporization gases being heated before the compression in the case of the non-cryogenic compressor,
the compression of the recovered vaporization gases is carried out by a non-cryogenic compressor and also comprises a step of cooling the compressed vaporization gases via a heat exchange with the flow of vaporization gas upstream of the compressor.

The invention can also relate to any alternative device or method comprising any combination of the features above or below within the scope of the claims

Further particularities and advantages will become apparent from reading the following description, made with reference to the figures, in which:

### BRIEF DESCRIPTION OF THE DRAWINGS

The invention will be understood better from reading the following description and from studying the accompanying figures. These figures are given only by way of illustration and do not in any way limit the invention.

The FIGURE is a schematic view in vertical section describing an example of the structure and operation of an installation according to the invention.

### DETAILED DESCRIPTION OF THE INVENTION

In all of the figures, the same reference signs refer to the same elements.

In this detailed description, the following embodiments are examples. Although the description refers to one or more embodiments, this does not mean that the features apply solely to a single embodiment. Single features of different embodiments can also be combined and/or interchanged in order to provide further embodiments.

The illustrated installation 1 for storing and distributing cryogenic fluid can be used, for example, for liquid hydrogen. The installation comprises a cryogenic reservoir 11 which is buried below the ground and a liquid withdrawal circuit 20 comprising an upstream end connected to the reservoir 11 and a downstream end located above the ground and designed to be connected to a consumer.

The withdrawal circuit 20 comprises a cryogenic pump 2 arranged above the ground. The installation 1 comprises a pipe 3 for the recovery of vaporization gas generated inside the pump 2, having an upstream end connected to the pump 2 and a downstream end connected to the reservoir 11. This pipe 3 for the recovery of vaporization gases comprises at least one device for controlling the pressure and/or flow rate of the vaporization gas returned to the reservoir 11. This at least one device 8, 9 for controlling the pressure and/or flow rate is configured to control the pressure inside the reservoir 11 at a pressure level which is greater than the pressure at the inlet of the pump 2.

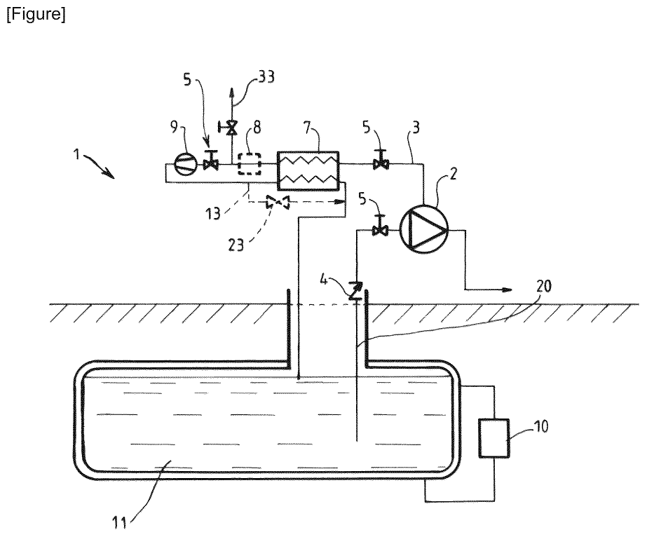

This device for controlling the pressure and/or flow rate is preferably configured to control the pressure inside the reservoir 11 above the pressure at the inlet of the pump so as to exceed the hydrostatic height between the reservoir and the inlet of the pump 2. For example, the device for controlling the pressure and/or flow rate is configured to control the pressure inside the reservoir at a level of between 5 mbar and 500 mbar above the pressure at the inlet of the pump, for example between 5 mbar and 500 mbar above the pressure at the inlet of the pump. The device for controlling the pressure and/or flow rate comprises at least one of: a heater 8, a heat exchanger 7 and a compressor 9, for example a cryogenic compressor. For reasons of simplification, [FIG. 1] shows the three aforementioned components in series. Naturally only one or two thereof can be provided.

The device for controlling the pressure and/or flow rate can comprise or consist of, for example, a heating heat exchanger 7 in series with a compressor 9.

The vaporization gas produced by the pump 2 is heated in the heat exchanger 7 and can then be returned to the reservoir 11.

The reservoir 11 can thus be kept pressurized in order to provide an efficient supply to the pump 2. The pump 2 which is relatively high is thus at a lower pressure than that of the reservoir 11. This low pressure represents, for example, between 10 and 100 mbar, since this is the pressure required to overcome the manometric height between the reservoir 11 and the intake of the pump 2 and the loss of pressure in the intake line. The recycling of the vaporization gas of the pump 2 in the reservoir 11 makes it possible to compensate for this relative difference in pressure.

This architecture makes it possible to recover the vaporization gases generated by the pump 2 during its various operating phases. When started up, the pump 2 produces vaporization gases in a relatively large quantity. After cooling down, during its operation, the pump 2 generates vaporization gases in a reduced quantity, for example due to leaks, thermal input, etc.

These vaporization gases can be collected and returned to the reservoir 11 via the recovery pipe 3.

This makes it possible to recover all or only a part of these vaporization gases during these different operating phases.

The vaporization gases are collected in the recovery pipe 3, are heated in the heating heat exchanger 7 and compressed before being returned to the reservoir. The compressor 9 makes it possible to circulate the flow of vaporization gas by compressing it to the pressure of the reservoir, for example to a level of several tens of millibars.

The compressed vaporization gas can pass back into the heating heat exchanger 7 in order to be cooled before being reinjected into the reservoir 11.

If this heating heat exchanger 7 is not sufficient to heat the gas before compression (excessive flow rate of vaporization gas, excessively cold temperature at the inlet, etc.) an additional (heating) heat exchanger 8 can be provided to complete the heating up to a determined temperature (the ambient temperature or intake temperature of the compressor).

This optional heater 8 is shown in dashed lines between the heating heat exchanger 7 and the compressor 9.

As illustrated, a valve 5, for example an isolating valve, can be arranged in series between the pump 5 and the heating heat exchanger 7. Similarly, a valve 5 is preferably provided upstream of the pump 2. A valve 5 can also be provided between the heating heat exchanger 7 and the compressor 9.

Similarly, a non-return valve 4 can be provided upstream of the pump 2.

As illustrated, the pipe for the recovery of the vaporization gases can provide two separate passages (preferably with a counterflow) in the heating heat exchanger 7, respectively before and after compression in the compressor 9, respectively to provide a heating of the vaporization gas before compression and a cooling before injecting the compressed gas into the reservoir 11.

As shown schematically, the pipe 3 for the recovery of the vaporization gases can also comprise a bypass line 13 from the heat exchanger and an assembly of one or more valves 23 configured to enable at least one part of the flow of vaporization gas to avoid passing into the heat exchanger 7. For example, the bypass line 13 makes it possible for all or part of the compressed flow of vaporization gas to avoid passing a second time into the heating heat exchanger 7. This makes it possible to increase the temperature of the compressed vaporization gases before the return to the reservoir 11 in order to stabilize the pressure in the reservoir 11 if it rises too rapidly.

As illustrated, the pipe 3 for the recovery of the vaporization gases can also comprise a branching T-piece 33 provided with a valve toward a discharge zone. This branching T-piece can be located between the heating heat exchanger 7 and the inlet of the compressor 9.

The reservoir 11 can comprise an autonomous pressurization device 10 which is configured to increase the pressure thereof, if required (by withdrawal, heating and reinjecting fluid).

This recovery and recycling of the vaporization gases makes it possible to keep the reservoir 11 at overpressure relative to the pump 2. This permanently guarantees a correct intake into the pump 2. If the recovered vaporization gases are insufficient for maintaining the pressure sufficiently high during the operation of the pump, the pressurization device 10 can be used to pressurize the reservoir 11.

Naturally, the invention is not limited to this exemplary embodiment described above. Thus, for example, the heating heat exchanger 7 and the compressor 9 could be replaced by a cryogenic compressor (which can compress the gas at a cryogenic temperature without the need for prior heating).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. An installation for storing and distributing a cryogenic fluid, the installation comprising:
a cryogenic reservoir which is buried below the ground;
a liquid withdrawal circuit comprising an upstream end connected to the reservoir and a downstream end located above the ground and configured to be connected to a consumer, wherein the liquid withdrawal circuit further comprises a cryogenic pump arranged above the ground; and
a pipe for the recovery of vaporization gas generated inside the cryogenic pump, having an upstream end connected to the cryogenic pump and a downstream end connected to the reservoir,
wherein the pipe for the recovery of the vaporization gases comprises at least one control device configured to control the pressure and/or flow rate of the vaporization gas returned to the reservoir,
wherein the control device is further configured to control the pressure inside the reservoir at a pressure level which is greater than the pressure at the inlet of the cryogenic pump.

2. The installation according to claim 1, wherein the control device is further configured to control the pressure inside the reservoir at a level of between 5 mbar and 500 mbar above the pressure at the inlet of the cryogenic pump.

3. The installation according to claim 1, wherein the control device comprises at least one of: a heater, a heat exchanger and a compressor, for example a cryogenic compressor.

4. The installation according to claim 3, wherein the control device comprises a heating heat exchanger and a compressor arranged in series.

5. The installation according to claim 4, wherein the pipe for the recovery of the vaporization gases comprises two separate passages in the heating heat exchanger, respectively before and after compression in the compressor, such that the pipe is configured to provide respectively a heating of the vaporization gas before compression and a cooling before injection into the reservoir.

6. The installation according to claim 4, wherein the pipe for the recovery of the vaporization gases comprises a bypass line from the heat exchanger and an assembly of one or more valves configured to enable at least one part of the flow of vaporization gas to avoid passing into the heat exchanger.

7. The installation according to claim 1, wherein the pipe for the recovery of the vaporization gases comprises a branching T-piece provided with a valve toward a discharge zone.

8. The installation according to claim 1, further comprising a pressurization device configured to pressurize the reservoir, wherein the pressurization device is autonomous and separate from the pipe for the recovery of the vaporization gases and the control device.

9. A method for the withdrawal of fluid using an installation, the method comprising the steps of:
providing the installation according to claim 1;
pumping of cryogenic liquid from the reservoir via the cryogenic pump,
recovering of the vaporization gas generated in the region of the cryogenic pump,
compressing the recovered vaporization gases; and
injecting the compressed gases into the reservoir at a determined pressure.

10. The method according to claim 9, wherein the compression of the recovered vaporization gases is carried out by a cryogenic compressor or by a non-cryogenic compressor, the vaporization gases being heated before the compression in the case of the non-cryogenic compressor.

11. The method according to claim 10, wherein the compression of the recovered vaporization gases is carried out by a non-cryogenic compressor and also comprises a step of cooling the compressed vaporization gases via a heat exchange with the flow of vaporization gas upstream of the compressor.
